(19) United States
(12) Patent Application Publication
(10) Pub. No.: US 2025/0151723 A1
(43) Pub. Date: May 15, 2025

(54) FUNGICIDAL COMBINATION, COMPOSITION, AND USE THEREOF

(71) Applicants: UPL MAURITIUS LIMITED, Port Louis (MU); UPL Europe Supply Chain GMBH, Rotkreuz/Risch (CH)

(72) Inventors: Ritesh SHETH, Durham, NC (US); Hendrik YPEMA, Durham, NC (US); Khuong Hoang Gia HUA, Durham, NC (US); Kalpesh Parimal Chokashi, Durham, NC (US); Vicente Gongora, Durham, NC (US)

(21) Appl. No.: 18/946,183

(22) Filed: Nov. 13, 2024

Related U.S. Application Data
(60) Provisional application No. 63/598,305, filed on Nov. 13, 2023.

(51) Int. Cl. A01N 31/08; A01N 59/02; A01N 59/20; A01P 3/00

(52) U.S. Cl. CPC A01N 31/08; A01N 59/02; A01N 59/20; A01P 3/00

(57) ABSTRACT

The present invention relates to a fungicidal combination. Particularly, the present invention relates to a fungicidal combination comprising a multi-site fungicide and salicylic acid, salts or analogues thereof. The present invention also relates to a fungicidal composition comprising said fungicidal combination, and methods of using thereof for controlling fungal infestation in plants, crops, or parts thereof.

### FIELD OF INVENTION

The present invention relates to a fungicidal combination. Particularly, the present invention relates to a fungicidal combination comprising a multi-site fungicide and salicylic acid, salts or analogues thereof. The present invention also relates to a fungicidal composition comprising said fungicidal combination, and methods of using thereof for controlling fungal infestation in plants, crops, or parts thereof.

### BACKGROUND

Fungicides play an important role in agriculture in controlling, eradicating, or preventing attack and damage to crops by fungal pathogens, thus safeguarding growth, health and yield of the crop. However, constant use of conventionally known fungicides has been generating resistance in fungal pathogens, thus creating a need for new fungicides or combinations of fungicides which act synergistically. The need for responsible environmental sustainability also poses a requirement for safe and effective fungicides which achieve the purpose in minimal doses.

Multi-site fungicides work by targeting many metabolic sites within the fungus. Since they have many target sites, these fungicides are usually at a lower risk of causing the development of fungicide resistance. Multi-site fungicides such as copper-based fungicides or sulphur-based fungicides are safe options to combat fungal pathogens and are a widespread tool for agriculturists. With a need to maximize the benefit, there is a need to combine these fungicides with agents which will help provide optimal effect with reduced dosages. There is therefore a need for effective and synergistic fungicidal solutions comprising multi-site fungicides, especially copper-based and sulphur-based fungicides.

### OBJECTS OF THE INVENTION

The present invention addresses the above unfulfilled requirement of the hour and targets to fill up the void for newer, effective, and synergistic fungicidal combinations and resulting solutions. It is an object of the present invention to provide fungicidal solutions which are effective at lower doses. Therefore, it becomes an object of the present invention to provide a novel, effective fungicidal combination comprising a multi-site fungicide; and salicylic acid, salts or analogues thereof. It is an object of the present invention to provide a novel, effective fungicidal combination comprising a multi-site fungicide; and salicylic acid, salts or analogues thereof. It is an object of the present invention to provide a synergistic fungicidal combination comprising a fungicide; and salicylic acid, salts or analogues thereof. It is an object of the present invention to provide a synergistic fungicidal combination comprising a multi-site fungicide; and salicylic acid, salts or analogues thereof. It is an objective of the present invention to provide a method of controlling fungal infestation of a plant, a crop or a part thereof by applying said combination or a composition comprising said combination. It is an objective of the present invention to provide a method of controlling fungal disease in a plant, a crop or a part thereof by applying said combination or a composition comprising said combination. It is an objective of the present invention to improve plant health, growth and yield by applying said combination or a composition comprising said combination. It is also an objective of the present invention to reduce the dosage of the fungicide without affecting the efficiency of controlling fungal infestation in a plant, a crop, or a part thereof.

### BRIEF SUMMARY

An aspect of the present invention provides a novel, effective fungicidal combination comprising a fungicide; and salicylic acid, salts or analogues thereof.

An aspect of the present invention provides a fungicidal combination comprising a multi-site fungicide; and salicylic acid, salts or analogues thereof.

An aspect of the present invention provides a fungicidally effective composition comprising a fungicide; and salicylic acid, salts or analogues thereof.

An aspect of the present invention provides a fungicidally effective composition comprising a multi-site fungicide; salicylic acid, salts or analogues thereof; and an agriculturally acceptable excipient.

An aspect of the present invention provides a method of controlling fungal infestation of a plant, a crop or a part thereof comprising applying a fungicidally effective combination comprising a multi-site fungicide; and salicylic acid, salts or analogues thereof; or a composition comprising said combination.

An aspect of the present invention provides a method of controlling fungal disease in a plant, a crop or a part thereof comprising applying a fungicidally effective combination comprising a multi-site fungicide; and salicylic acid, salts or analogues thereof; or a composition comprising said combination.

An aspect of the present invention provides a method to improve plant health, growth and yield comprising applying a fungicidally effective combination comprising a multi-site fungicide; and salicylic acid, salts or analogues thereof; or a composition comprising said combination.

In an embodiment, 10%-90% dose reduction of the multi-site fungicide as compared to the standard farmer practice is achieved through the combinations, compositions or methods encompassed by the present invention.

An aspect of the present invention provides a use of a fungicidally effective combination comprising a multi-site fungicide; and salicylic acid, salts or analogues thereof; or a composition comprising said combination for controlling fungal infestation and/or fungal disease of a plant, a crop, or a part thereof.

An aspect of the present invention provides a kit-of-parts comprising a first component comprised of a multi-site fungicide, and a second component comprised of salicylic acid, salts or analogues thereof. The first and/or second components may further comprise an agriculturally acceptable excipient.

An aspect of the present invention provides a kit-of-parts comprising a first component comprised of a multi-site fungicide, a second component comprised of salicylic acid, salts or analogues thereof; and optionally a third or more components comprised of an agriculturally acceptable excipient.

In an embodiment, the kit-of-parts may further comprise a set of instructions on mixing, use and application of the components comprised therein.

### DETAILED DESCRIPTION

For the purposes of the following detailed description, it is to be understood that the invention may assume various alternative variations and step sequences, except where expressly specified to the contrary. Moreover, other than in any operating examples, or where otherwise indicated, all numbers expressing, for example, quantities of materials/ingredients used in the specification are to be understood as being modified in all instances by the term “about” and is meant to encompass variations of ±10%, ±5%, ±1%, ±0.5%, or even ±0.1% of the specified value as well as the specified value.

Thus, before describing the present invention in detail, it is to be understood that this invention is not limited to particularly exemplified systems or process parameters that may of course, vary. It is also to be understood that the terminology used herein is for the purpose of describing particular embodiments of the invention only and is not intended to limit the scope of the invention in any manner. The use of examples anywhere in this specification including examples of any terms discussed herein is illustrative only, and in no way limits the scope and meaning of the invention or of any exemplified term. Likewise, the invention is not limited to various embodiments given in this specification. Unless otherwise defined, all technical and scientific terms used herein have the same meaning as commonly understood by one of ordinary skill in the art to which this invention pertains. In the case of conflict, the present document, including definitions will control.

It must be noted that, as used in this specification, the singular forms “a,” “an” and “the” include plural referents unless the content clearly dictates otherwise. The terms “preferred” and “preferably” refer to embodiments of the invention that may afford certain benefits, under certain circumstances.

As used herein, the terms “comprising” “including,” “having,” “containing,” “involving,” and the like are to be understood to be open-ended, i.e., to mean including but not limited to.

In any aspect or embodiment described hereinbelow, the phrase comprising may be replaced by the phrases “consisting of” or “consisting essentially of” or “consisting substantially of”. In these aspects or embodiment, the combination or composition described includes or comprises or consists of or consists essentially of or consists substantially of the specific components recited therein, to the exclusion of other herbicides or fungicides or insecticide or plant growth promoting agents or adjuvants, or excipients not specifically recited therein.

The term “plants” include, but are not limited to, germinant seeds, emerging seedlings, plants emerging from vegetative propagules, and established vegetation. The term “plant” as used herein refers to any vegetation to which the compositions of the present disclosure can be applied for any purposes or any treatment. The term covers a whole plant or a part thereof, such as stems, branches, bark, pistils, flowers, petals, sepals, roots, rhizomes, buds, bulbs, tubers, petioles, nodes, internodes, leaves, leaflets, meristems, root tips, shoot tips, fruits, reproductive organs such as anther, stamen, carpel, ovary, style, stigma, and so forth. The term also covers seeds, seedlings, or any plant propagation material. The term “plant propagation material” is to be understood to denote all the generative parts of the plant such as seeds and vegetative plant material such as cuttings and tubers (e. g. potatoes), which can be used for the multiplication of the plant. This includes seeds, roots, fruits, tubers, bulbs, rhizomes, shoots, sprouts and other parts of plants. Seedlings and young plants, which are to be transplanted after germination or after emergence from soil, may also be included. These plant propagation materials may be treated prophylactically with a plant protection compound either at or before planting or transplanting. In an embodiment, the term includes agronomically useful plants, for example for example vegetable, fruit and cereal crops, and ornamental plants. The agronomically useful plants are angiosperms selected from the group consisting of Apiaceae, Asteraceae, Brassicaceae, Chenopodiaceae, Convolvulaceae, Cucurbitaceae, Fabaceae, Gramineae, Liliaceae, Polygonaceae, Rosaceae, Solanaceae, Poaceae, the Vitaceae. The term includes crops, cereals, fruits, vegetables, nuts, vines, nursery plants and flowers. Non-limiting examples of target plant include corn, cereals such as rice, wheat, barley, rye, oat, sorghum, millet, triticale, buckwheat, etc.; cotton, soybean, beet, row crops, legumes, grams, sugar cane, tobacco, etc.; oilseeds such as oilseed rape, peanut/groundnut, rapeseed, sunflower, etc.; vegetables: solanaceous vegetables such as eggplant, tomato, pimento, pepper, potato, etc., cucurbit vegetables such as cucumber, pumpkin, zucchini, water melon, melon, squash, gourds, muskmelon, etc., cruciferous vegetables such as radish, white turnip, horseradish, kohlrabi, cabbage, leaf mustard, broccoli, cauliflower, brussels sprouts, kale, etc., asteraceous vegetables such as burdock, crown daisy, artichoke, lettuce, etc, liliaceous vegetables such as green onion, onion, shallot, garlic, and asparagus, ammiaceous vegetables such as carrot, parsley, celery, parsnip, leek, etc., chenopodiaceous vegetables such as spinach, swiss chard, etc., lamiaceous vegetables such as Perilla frutescens, mint, basil, etc.; herbs and spices such as coriander, chamomile, cassia, catnip, clove, cumin, curry, cilantro, cinnamon, cardamom, dill, anise, juniper, lavender, parsley, rosemary, marigold, mustard, nutmeg, fennel, poppy, thyme, vanilla, saffron, poppy, sage, wintergreen, etc.; flowers, foliage plants, turf grasses, fruits: pome fruits such apple, pear, quince, guava, etc, stone fleshy fruits such as peach, plum, nectarine, cherry, apricot, prune, etc., citrus fruits such as orange, lemon, lime, grapefruit, mandarin, malta, kumquat, pummelo, tangerine, tangor, uniq, etc., nuts such as chestnuts, walnuts, hazelnuts, almond, pistachio, cashew nuts, macadamia nuts, pecan nut, cashew nut, hazel nut, pine nut, etc. berries such as caneberry, strawberry, blueberry, cranberry, blackberry, raspberry, coryberry, darrowberry, dewberry, thornless berry, evergreen blackberry, himalayaberry, hullberry, lavacaberry, loganberry, lowberry, lucretiaberry, mammoth blackberry, marionberry, mora, mures deronce, nectarberry, olallieberry, evergreen berry, phenomenalberry, rangeberry, ravenberry, rossberry, dewberry, tayberry, youngberry, zarzamora, aronia berry, currant, elderberry, barberry, gooseberry, honeysuckle, huckleberry, jostaberry, juneberry, lingonberry, salal, seabuckthorn, bayberry, buffaloberry, chokecherry, maypop, mulberry, bearberry, bilberry, cloudberry, muntries, partridgeberry, etc., grape, kaki fruit, kiwi fruit, olive, plum, banana, coffee, date palm, coconuts, papaya, persimmon, avocado, dragon fruit, pomegranate, lychee, jackfruit, pineapple, passionfruit, sapota, etc., trees other than fruit trees; tea, mulberry, flowering plant, trees such as ash, birch, dogwood, eucalyptus, Ginkgo biloba, lilac, maple, Quercus, poplar, Judas tree, Liquidambar formosana, plane tree, zelkova, japanese arborvitae, fir wood, hemlock, juniper, Pinus, Picea, and Taxus cuspidate, etc., other crops such as chive, day lily, Elegans hosta, Fritillaria, gojiberry, okra, pea, hops, beans, guar, radish, amaranth, jute, fenugreek, lentils, chickpea, artichoke, rhubarb, licorice, sweet potato, Dioscorea japonica, colocasia, ornamental grasses (lawn turf, sod, etc.), varieties and cultivars thereof.

An effective fungal disease control in plants, crops or a part thereof can be achieved by usage of fungicides appropriately. The activity of fungicides can be enhanced in various ways to achieve the maximum benefit. One of the ways is to use different fungicidal combinations. However, identifying appropriate combinations, their agrochemical application rates, and ratio of the combinations is essential to achieve efficacious control, which is not straight forward. Accordingly, the present disclosure bridges the gap to provide novel, effective fungicidal combinations which also may be synergistic in their action and effect.

Thus, an embodiment of the present invention provides a novel, effective fungicidal combination comprising a fungicide; and salicylic acid, salts or analogues thereof.

In a preferred embodiment, the fungicide is a multisite fungicide.

In a preferred embodiment, the fungicide is a multisite fungicide. In a preferred embodiment, the multi-site fungicide is selected from an inorganic fungicide, a dithio-carbamate, a phthalimide, a chloronitrile, a sulfamide, a bis-guanidine, a triazine, a quinone, a quinoxaline, a maleimide, a thiocarbamate, or combinations thereof. In a preferred embodiment, the multi-site fungicide is an inorganic fungicide selected from copper, copper complexes, copper salts, sulphur, sulphur complexes, sulphur salts, and combinations thereof; a dithio-carbamate selected from amobam, ferbam, mancozeb, maneb, metiram, propineb, thiram, zinc, thiazole, zineb, ziram, and combinations thereof; a phthalimide selected from captan, captafol, folpet, and combinations thereof; a chloronitrile such as chlorothalonil; a sulfamide selected from dichlofluanid, tolylfluanid, and a combination thereof; a bis-guanidine selected from guazatine, iminoctadine, and a combination thereof; a triazine such as anilazine; a quinone such as dithianon; a quinoxaline selected from chinomethionat, quinomethionate, and a combination thereof; a maleimide such as fluoroimide, a thiocarbamate such as methasulfocarb; or combinations of the above.

In a preferred embodiment, the multisite fungicide is copper.

In a preferred embodiment, the multisite fungicide is copper sulphate or tribasic copper sulphate.

In a preferred embodiment, the multisite fungicide is mancozeb.

In a preferred embodiment, the multisite fungicide is captan.

In a preferred embodiment, the multisite fungicide is folpet.

In a preferred embodiment, the multisite fungicide is ziram.

In an embodiment, the fungicide is a multi-site fungicide as provided herein the specification, provided multi-site fungicide does not comprise mancozeb. Therefore, the multi-site fungicide is an inorganic fungicide selected from copper, copper complexes, copper salts, sulphur, sulphur complexes, sulphur salts, and combinations thereof; a dithio-carbamate selected from amobam, ferbam, maneb, metiram, propineb, thiram, zinc, thiazole, zineb, ziram, and combinations thereof; a phthalimide selected from captan, captafol, folpet, and combinations thereof; a chloronitrile such as chlorothalonil; a sulfamide selected from dichlofluanid, tolylfluanid, and a combination thereof; a bis-guanidine selected from guazatine, iminoctadine, and a combination thereof; a triazine such as anilazine; a quinone such as dithianon; a quinoxaline selected from chinomethionat, quinomethionate, and a combination thereof; a maleimide such as fluoroimide, a thiocarbamate such as methasulfocarb; or combinations of the above.

An embodiment of the present invention provides a fungicidal combination comprising a multi-site fungicide; and salicylic acid, salts or analogues thereof.

In an embodiment, analogues of salicylic acid include 2,6-dichloroisonicotinic acid, benzothiadiazole, 5-aminosalicylic acid, 5-methylsalicylic acid, acetylsalicylic acid, 3-hydroxybenzoic acid, acibenzolar-S-methyl, β-aminobutyric acid, 4-hydroxybenzoic acid, and combinations thereof.

In an embodiment, the salts of salicylic acid include sodium, potassium, calcium, magnesium salts of salicylic acid and any salt as can be normally construed by a person skilled in the art. In a preferred embodiment, the salt is potassium salicylate.

In an embodiment, the multi-site fungicide; and salicylic acid, salts or analogues thereof are combined in a ratio ranging from about 1:100 to about 100:1. In an embodiment, the multi-site fungicide; and salicylic acid, salts or analogues thereof are combined in a ratio ranging from about 1:90 to about 90:1. In an embodiment, the multi-site fungicide; and salicylic acid, salts or analogues thereof are combined in a ratio ranging from about 1:80 to about 80:1. In an embodiment, the multi-site fungicide; and salicylic acid, salts or analogues thereof are combined in a ratio ranging from about 1:70 to about 70:1. In an embodiment, the multi-site fungicide; and salicylic acid, salts or analogues thereof are combined in a ratio ranging from about 1:60 to about 60:1. In an embodiment, the multi-site fungicide; and salicylic acid, salts or analogues thereof are combined in a ratio ranging from about 1:50 to about 50:1. In an embodiment, the multi-site fungicide; and salicylic acid, salts or analogues thereof are combined in a ratio ranging from about 1:40 to about 40:1. In an embodiment, the multi-site fungicide; and salicylic acid, salts or analogues thereof are combined in a ratio ranging from about 1:30 to about 30:1. In an embodiment, the multi-site fungicide; and salicylic acid, salts or analogues thereof are combined in a ratio ranging from about 1:20 to about 20:1. In an embodiment, the multi-site fungicide; and salicylic acid, salts or analogues thereof are combined in a ratio ranging from about 1:10 to about 10:1.

In an embodiment, the fungicidal combination of the present invention comprises copper and salicylic acid, salts or analogues thereof. In an embodiment, the fungicidal combination of the present invention comprises copper and salicylic acid, salts or analogues thereof combined in a ratio ranging from about 1:60 to 60:1. In another embodiment, said combination comprises potassium salicylate.

In an embodiment, the fungicidal combination of the present invention comprises tribasic copper sulphate and salicylic acid, salts or analogues thereof. In an embodiment, the fungicidal combination of the present invention comprises tribasic copper sulphate and salicylic acid, salts or analogues thereof combined in a ratio ranging from about 1:60 to 60:1. In another embodiment, said combination comprises potassium salicylate.

In an embodiment, the fungicidal combination of the present invention comprises mancozeb and salicylic acid, salts or analogues thereof. In an embodiment, the fungicidal combination of the present invention comprises mancozeb and salicylic acid, salts or analogues thereof combined in a ratio ranging from about 1:40 to 4:1. In another embodiment, said combination comprises potassium salicylate.

In an embodiment, the fungicidal combination of the present invention comprises captan and salicylic acid, salts or analogues thereof. In an embodiment, the fungicidal combination of the present invention comprises captan and salicylic acid, salts or analogues thereof combined in a ratio ranging from about 1:13 to 6:1. In another embodiment, said combination comprises potassium salicylate.

In an embodiment, the fungicidal combination of the present invention comprises folpet and salicylic acid, salts or analogues thereof. In an embodiment, the fungicidal combination of the present invention comprises folpet and salicylic acid, salts or analogues thereof combined in a ratio ranging from about 1:33 to 3:1. In another embodiment, said combination comprises potassium salicylate.

In an embodiment, the fungicidal combination of the present invention comprises ziram and salicylic acid, salts or analogues thereof. In an embodiment, the fungicidal combination of the present invention comprises ziram and salicylic acid, salts or analogues thereof combined in a ratio ranging from about 1:20 to 20:1. In another embodiment, said combination comprises potassium salicylate.

In an embodiment, said combination comprises one or more multi-site fungicides. In an embodiment, said combination comprises two or more multi-site fungicides. Said fungicides may be selected from the list of multi-site fungicides provided herein the specification.

In various embodiments, the fungicidal activity of a combination according to the present invention exceeds the total of the activities of the individual active compounds. For the two active compounds in a combination or when applied together to form a combination, the activity will be greater than the sum of the single active compound alone. Thus, in various embodiments, fungicidal combinations include combinations which are synergistic for control of one or more fungi or fungal pathogens.

An embodiment of the present invention provides a novel, effective fungicidal combination comprising a multi-site fungicide; and salicylic acid, salts or analogues thereof.

An embodiment of the present invention provides a synergistic fungicidal combination comprising a multi-site fungicide; and salicylic acid, salts or analogues thereof.

An embodiment of the present invention provides an effective and synergistic fungicidal combination comprising a multi-site fungicide; and salicylic acid, salts or analogues thereof.

An embodiment of the present invention provides a fungicidally effective composition comprising a fungicide; and salicylic acid, salts or analogues thereof. In an embodiment, said fungicide; and salicylic acid, salts or analogues thereof are present in a synergistic combination in said composition.

An embodiment of the present invention provides a fungicidally effective composition comprising a multi-site fungicide; and salicylic acid, salts or analogues thereof. In an embodiment, the multi-site fungicide; and salicylic acid, salts or analogues thereof are present in a synergistic combination in said composition.

In an embodiment, the total amount of the multi-site fungicide in the composition may typically be in the range of about 0.1% to about 99% by weight of the composition. The total amount of the salicylic acid, salts or analogues thereof in the composition may be in the range of about 0.1% to about 99% by weight of the composition.

In an embodiment, the total amount of the multi-site fungicide in the composition may typically be in the range of about 0.1% to about 99% by weight of the composition.

In an embodiment, the amount of the fungicide in the combinations or compositions of the present invention may range from about 0.001 g ai/L to about 2000 g ai/L.

In an embodiment, the amount of the multi-site fungicide in the combinations or compositions of the present invention may range from about 0.001 g ai/L to about 2000 g ai/L.

In an embodiment, the amount of the copper fungicide or copper-based fungicide in the combinations or compositions of the present invention may range from about 100 mg ai/L to about 1000 mg ai/L. In an embodiment, the amount of the copper fungicide or copper-based fungicide in the combinations or compositions of the present invention may range from about 200 mg ai/L to about 950 mg ai/L. In an embodiment, the amount of the copper fungicide or copper-based fungicide in the combinations or compositions of the present invention may range from about 300 mg ai/L to about 900 mg ai/L. In an embodiment, the amount of the copper fungicide or copper-based fungicide in the combinations or compositions of the present invention may range from about 400 mg ai/L to about 850 mg ai/L. In an embodiment, the amount of the copper fungicide or copper-based fungicide in the combinations or compositions of the present invention may range from about 500 mg ai/L to about 800 mg ai/L. In an embodiment, the amount of the copper fungicide or copper-based fungicide in the combinations or compositions of the present invention may range from about 600 mg ai/L to about 750 mg ai/L. In a preferred embodiment, the amount of the copper fungicide or copper-based fungicide in the combinations or compositions of the present invention is about 750 mg ai/L. In a preferred embodiment, the amount of the copper fungicide or copper-based fungicide in the combinations or compositions of the present invention ranges from about 100 mg ai/L to about 750 mg ai/L.

In an embodiment, the amount of the mancozeb in the combinations or compositions of the present invention may range from about 1 mg ai/L to about 200 mg ai/L. In an embodiment, the amount of the mancozeb in the combinations or compositions of the present invention may range from about 7 mg ai/L to about 100 mg ai/L.

In an embodiment, the amount of the captan in the combinations or compositions of the present invention may range from about 1 mg ai/L to about 200 mg ai/L. In an embodiment, the amount of the captan in the combinations or compositions of the present invention may range from about 2 mg ai/L to about 100 mg ai/L.

In an embodiment, the amount of the folpet in the combinations or compositions of the present invention may range from about 1 mg ai/L to about 200 mg ai/L. In an embodiment, the amount of the folpet in the combinations or compositions of the present invention may range from about 2 mg ai/L to about 100 mg ai/L.

In an embodiment, the amount of the ziram in the combinations or compositions of the present invention may range from about 1 mg ai/L to about 200 mg ai/L. In an embodiment, the amount of the ziram in the combinations or compositions of the present invention may range from about 2 mg ai/L to about 100 mg ai/L.

In an embodiment, the amount of the salicylic acid, salts or analogues thereof in the combinations or compositions of the present invention may range from about 1 mg ai/L to about 2000 mg ai/L. In an embodiment, the amount of the salicylic acid, salts or analogues thereof in the combinations or compositions of the present invention may range from about 1 mg ai/L to about 1700 mg ai/L. In an embodiment, the amount of the salicylic acid, salts or analogues thereof in the combinations or compositions of the present invention may range from about 1 mg ai/L to about 800 mg ai/L. In an embodiment, the amount of the salicylic acid, salts or analogues thereof in the combinations or compositions of the present invention may range from about 10 mg ai/L to about 600 mg ai/L. In an embodiment, the amount of the salicylic acid, salts or analogues thereof in the combinations or compositions of the present invention may range from about 20 mg ai/L to about 500 mg ai/L. In an embodiment, the amount of the salicylic acid, salts or analogues thereof in the combinations or compositions of the present invention may range from about 40 mg ai/L to about 450 mg ai/L.

An embodiment of the present invention provides a fungicidally effective composition comprising a fungicide; salicylic acid, salts or analogues thereof; and an agriculturally acceptable excipient.

An embodiment of the present invention provides a fungicidally effective composition comprising a multi-site fungicide; salicylic acid, salts or analogues thereof; and an agriculturally acceptable excipient.

The agrochemically suitable excipient may be any one or a combination of adjuvants, co-solvents, surfactants, colorants, dispersants, emulsifiers, thickeners, antifreeze agents, biocides, anti-foam agents, stabilizers, wetting agents or a mixture thereof which may be optionally added to the compositions of the present invention.

The surfactants may be selected from non-ionic, anionic, or cationic surfactants.

Examples of nonionic surfactants include polyarylphenol polyethoxy ethers, polyalkylphenol polyethoxy ethers, polyglycol ether derivatives of saturated fatty acids, polyglycol ether derivatives of unsaturated fatty acids, polyglycol ether derivatives of aliphatic alcohols, polyglycol ether derivatives of cycloaliphatic alcohols, fatty acid esters of polyoxyethylene sorbitan, alkoxylated vegetable oils, alkoxylated acetylenic diols, polyalkoxylated alkylphenols, fatty acid alkoxylates, sorbitan alkoxylates, sorbitol esters, C₈-C₂₂ alkyl or alkenyl polyglycosides, polyalkoxy styrylaryl ethers, alkylamine oxides, block copolymer ethers, polyalkoxylated fatty glyceride, polyalkylene glycol ethers, linear aliphatic or aromatic polyesters, organo silicones, polyaryl phenols, sorbitol ester alkoxylates, polyalkylene oxide block copolymers, acrylic copolymers and mono- and diesters of ethylene glycol and mixtures thereof.

Examples of anionic surfactants include alcohol sulfates, alcohol ether sulfates, alkylaryl ether sulfates, alkylaryl sulfonates such as alkylbenzene sulfonates and alkylnaphthalene sulfonates and salts thereof, alkyl sulfonates, mono- or di-phosphate esters of polyalkoxylated alkyl alcohols or alkylphenols, mono- or di-sulfosuccinate esters of C₁₂-C₁₅ alkanols or polyalkoxylated C₁₂-C₁₅ alkanols, alcohol ether carboxylates, phenolic ether carboxylates, polybasic acid esters of ethoxylated polyoxyalkylene glycols consisting of oxybutylene or the residue of tetrahydrofuran, sulfoalkylamides and salts thereof such as N-methyl-N-oleoyltaurate Na salt, polyoxyalkylene alkylphenol carboxylates, polyoxyalkylene alcohol carboxylates alkyl polyglycoside/alkenyl succinic anhydride condensation products, alkyl ester sulfates, napthalene sulfonates, naphthalene formaldehyde condensates, alkyl sulfonamides, sulfonated aliphatic polyesters, sulfate esters of styrylphenyl alkoxylates, and sulfonate esters of styrylphenyl alkoxylates and their corresponding sodium, potassium, calcium, magnesium, zinc, ammonium, alkylammonium, diethanolammonium, or triethanolammonium salts, salts of ligninsulfonic acid such as the sodium, potassium, magnesium, calcium or ammonium salt, polyarylphenol polyalkoxyether sulfates and polyarylphenol polyalkoxyether phosphates, and sulfated alkyl phenol ethoxylates and phosphated alkyl phenol ethoxylates.

Cationic surfactants include alkanol amides of C₈-C₁₈ fatty acids and C₈-C₁₈ fatty amine polyalkoxylates, C₁₀-C₁₈ alkyldimethylbenzylammonium chlorides, coconut alkyldimethylaminoacetic acids, and phosphate esters of C₈-C₁₈ fatty amine polyalkoxylates.

Emulsifiers which can be advantageously employed herein can be readily determined by those skilled in the art and include various non-ionic, anionic, cationic and amphoteric emulsifiers, or a blend of two or more emulsifiers. Examples of nonionic emulsifiers useful in preparing the emulsifiable concentrates include the polyalkylene glycol ethers and condensation products of alkyl and aryl phenols, aliphatic alcohols, aliphatic amines or fatty acids with ethylene oxide, propylene oxides such as the ethoxylated alkyl phenols and carboxylic esters solubilized with the polyol or polyoxyalkylene. Cationic emulsifiers include quaternary ammonium compounds and fatty amine salts. Anionic emulsifiers include the oil-soluble salts (e.g., calcium) of alkylaryl sulfonic acids, oil-soluble salts or sulfated polyglycol ethers and appropriate salts of phosphated polyglycol ether.

In an embodiment, colorants may be selected from iron oxide, titanium oxide and Prussian Blue, and organic dyestuffs, such as alizarin dyestuffs, azo dyestuffs or metal phthalocyanine dyestuffs, and trace elements, such as salts of iron, manganese, boron, copper, cobalt, molybdenum and zinc.

Another embodiment involves addition of a thickener or binder which may be selected from but not limited to molasses, granulated sugar, alginates, karaya gum, jaguar gum, tragacanth gum, polysaccharide gum, mucilage, xanthan gum or combination thereof. In another embodiment, the binder may be selected from silicates such as magnesium aluminium silicate, polyvinyl acetates, polyvinyl acetate copolymers, polyvinyl alcohols, polyvinyl alcohol copolymers, celluloses, including ethylcelluloses and methylcelluloses, hydroxymethyl celluloses, hydroxypropylcelluloses, hydroxymethylpropyl-celluloses, polyvinylpyrolidones, dextrins, malto-dextrins, polysaccharides, fats, oils, proteins, gum arabics, shellacs, vinylidene chloride, vinylidene chloride copolymers, calcium lignosulfonates, acrylic copolymers, starches, polyvinylacrylates, zeins, gelatin, carboxymethylcellulose, chitosan, polyethylene oxide, acrylimide polymers and copolymers, polyhydroxyethyl acrylate, methylacrylimide monomers, alginate, ethylcellulose, polychloroprene and syrups or mixtures thereof; polymers and copolymers of vinyl acetate, methyl cellulose, vinylidene chloride, acrylic, cellulose, polyvinylpyrrolidone and polysaccharide; polymers and copolymers of vinylidene chloride and vinyl acetate-ethylene copolymers; combinations of polyvinyl alcohol and sucrose; plasticizers such as glycerol, propylene glycol, polyglycols.

In another embodiment, antifreeze agent(s) added to the composition may be alcohols selected from the group comprising of but not limited to ethylene glycol, 1,2-propylene glycol, 1,3-propylene glycol, 1,2-butanediol, 1,3-butanediol, 1,4-butanediol, 1,4-pentanediol, 3-methyl-1,5-pentanediol, 2,3-dimethyl-2,3-butanediol, trimethylol propane, mannitol, sorbitol, glycerol, pentaerythritol, 1,4-cyclohexanedimethanol, xylenol, bisphenols such as bisphenol A or the like. In addition, ether alcohols such as diethylene glycol, triethylene glycol, tetraethylene glycol, polyoxyethylene or polyoxypropylene glycols of molecular weight up to about 4000, diethylene glycol monomethylether, diethylene glycol monoethylether, triethylene glycol monomethylether, butoxyethanol, butylene glycol monobutylether, dipentaerythritol, tripentaerythritol, tetrapentaerythritol, diglycerol, triglycerol, tetraglycerol, pentaglycerol, hexaglycerol, heptaglycerol, octaglycerol.

According to an embodiment, biocides may be selected from benzothiazoles, 1,2-benzisothiazolin-3-one, sodium dichloro-s-triazinetrione, sodium benzoate, potassium sorbate, 1,2-phenyl-isothiazolin-3-one, inter chloroxylenol paraoxybenzoate butyl.

According to an embodiment, antifoam agent may be selected from Polydimethoxysiloxane, polydimethylsiloxane, Alkyl poly acrylates, Castor Oil, Fatty Acids, Fatty Acids Esters, Fatty Acids Sulfate, Fatty Alcohol, Fatty Alcohol Esters, Fatty Alcohol Sulfate, Foot Olive Oil, Mono & Di Glyceride, Paraffin Oil, Paraffin Wax, Poly Propylene Glycol, Silicones Oil, Vegetable Fats, Vegetable Fats Sulfate, Vegetable Oil, Vegetable Oil Sulfate, Vegetable Wax, Vegetable Wax Sulfate, agents based on silicon or magnesium stearate.

The additives to be used for the formulation include, for example, a solid carrier such as kaolinite, sericite, diatomaceous earth, slaked lime, calcium carbonate, talc, white carbon, kaoline, bentonite, clay, sodium carbonate, sodium bicarbonate, mirabilite, zeolite or starch; a solvent such as water, toluene, xylene, solvent naphtha, dioxane, dimethylsulfoxide, N,N-dimethylformamide, dimethylacetamide, N-methyl-2-pyrrolidone or an alcohol; an anionic surfactant such as a salt of fatty acid, a benzoate, a polycarboxylate, a salt of alkylsulfuric acid ester, an alkyl sulfate, an alkylaryl sulfate, an alkyl diglycol ether sulfate, a salt of alcohol sulfuric acid ester, an alkyl sulfonate, an alkylaryl sulfonate, an aryl sulfonate, a lignin sulfonate, an alkyldiphenylether disulfonate, a polystyrene sulfonate, a salt of alkylphosphoric acid ester, an alkylaryl phosphate, a styrylaryl phosphate, a salt of polyoxyethylene alkyl ether sulfuric acid ester, a polyoxyethylene alkylaryl ether sulfate, a salt of polyoxyethylene alkylaryl ether sulfuric acid ester, a polyoxyethylene alkyl ether phosphate, a salt of polyoxyethylene alkylaryl phosphoric acid ester, a salt of polyoxyethylene aryl ether phosphoric acid ester, a naphthalene sulfonic acid condensed with formaldehyde or a salt of alkylnaphthalene sulfonic acid condensed with formaldehyde; a nonionic surfactant such as a sorbitan fatty acid ester, a glycerin fatty acid ester, a fatty acid polyglyceride, a fatty acid alcohol polyglycol ether, acetylene glycol, acetylene alcohol, an oxyalkylene block polymer, a polyoxyethylene alkyl ether, a polyoxyethylene alkylaryl ether, a polyoxyethylene styrylaryl ether, a polyoxyethylene glycol alkyl ether, polyethylene glycol, a polyoxyethylene fatty acid ester, a polyoxyethylene sorbitan fatty acid ester, a polyoxyethylene glycerin fatty acid ester, a polyoxyethylene hydrogenated castor oil or a polyoxypropylene fatty acid ester; and a vegetable oil or mineral oil such as olive oil, kapok oil, castor oil, palm oil, camellia oil, coconut oil, sesame oil, corn oil, rice bran oil, peanut oil, cottonseed oil, soybean oil, rapeseed oil, linseed oil, tung oil or liquid paraffins. These additives may suitably be selected for use alone or in combination as a mixture of two or more of them, so long as the object of the present invention is met. Further, additives other than the above-mentioned may be suitably selected for use among those known in this field. For example, various additives commonly used, such as a filler, a thickener, an anti-settling agent, an anti-freezing agent, a dispersion stabilizer, a safener, an anti-mold agent, a bubble agent, a disintegrator and a binder, may be used.

The agrochemical formulation may also comprise one or more antioxidants. Preferably, the agrochemical formulation comprises an antioxidant. Antioxidants are, for example, amino acids (e.g. glycine, histidine, tyrosine, tryptophan) and derivatives thereof, imidazole and imidazole derivatives (e.g. urocanic acid), peptides, such as, for example, D,L-carnosine, D-carnosine, L-carnosine and derivatives thereof (e.g. anserine), carotenoids, carotenes (e.g. α-carotene, β-carotene, lycopene) and derivatives thereof, lipoic acid and derivatives thereof (e.g. dihydrolipoic acid), aurothioglucose, propylthiouracil and further thio compounds (e.g. thioglycerol, thiosorbitol, thioglycolic acid, thioredoxin, glutathione, cysteine, cystine, cystamine and the glycosyl, N-acetyl, methyl, ethyl, propyl, amyl, butyl, lauryl, palmitoyl, oleyl, γ-linoleyl, cholesteryl and glyceryl esters thereof), and salts thereof, dilauryl thiodipropionate, distearyl thiodipropionate, thiodipropionic acid and derivatives thereof (esters, ethers, peptides, lipids, nucleotides, nucleosides and salts), and sulfoximine compounds (e.g. buthionine sulfoximines, homocysteine sulfoximine, buthionine sulfones, penta-, hexa-, heptathionine sulfoximine) in very low tolerated doses (e.g. pmol/kg to pmol/kg), also metal chelating agents (e.g. α-hydroxy fatty acids, EDTA, EGTA, phytic acid, lactoferrin), α-hydroxy acids (e.g. citric acid, lactic acid, malic acid), humic acids, bile acid, bile extracts, gallic esters (e.g. propyl, octyl and dodecyl gallate), flavonoids, catechins, bilirubin, biliverdin and derivatives thereof, unsaturated fatty acids and derivatives thereof (e.g. γ-linolenic acid, linoleic acid, arachidonic acid, oleic acid), folic acid and derivatives thereof, hydroquinone and derivatives thereof (e.g. arbutin), ubiquinone and ubiquinol, and derivatives thereof, vitamin C and derivatives thereof (e.g. ascorbyl palmitate, stearate, dipalmitate, acetate, Mg ascorbyl phosphates, sodium and magnesium ascorbate, disodium ascorbyl phosphate and sulfate, potassium ascorbyl tocopheryl phosphate, chitosan ascorbate), isoascorbic acid and derivatives thereof, tocopherols and derivatives thereof (e.g. tocopheryl acetate, linoleate, oleate and succinate, tocophereth-5, tocophereth-10, tocophereth-12, tocophereth-18, tocophereth-50, tocophersolan), vitamin A and derivatives (e.g. vitamin A palmitate), the coniferyl benzoate of benzoin resin, rutin, rutinic acid and derivatives thereof, disodium rutinyl disulfate, cinnamic acid and derivatives thereof (e.g. ferulic acid, ethyl ferulate, caffeeic acid), kojic acid, chitosan glycolate and salicylate, butylhydroxytoluene, butylhydroxyanisol, nordihydroguaiacic acid, nordihydroguaiaretic acid, trihydroxybutyrophenone, uric acid and derivatives thereof, mannose and derivatives thereof, selenium and selenium derivatives (e.g. selenomethionine), stilbenes and stilbene derivatives (e.g. stilbene oxide, trans-stilbene oxide). According to the invention, suitable derivatives (salts, esters, sugars, nucleotides, nucleosides, peptides and lipids) and mixtures of these specified active ingredients or plant extracts (e.g. teatree oil, rosemary extract and rosemarinic acid) which comprise these antioxidants can be used. In general, mixtures of the aforementioned antioxidants are possible.

According to an embodiment, examples of suitable solvents are water, aromatic solvents (for example, xylene), paraffins (for example mineral oil fractions such as kerosene or diesel oil), coal tar oils and oils of vegetable or animal origin, aliphatic, cyclic and aromatic hydrocarbons, for example toluene, xylene, paraffin, tetrahydronaphthalene, alkylated naphthalenes or their derivatives, alcohols (for example methanol, butanol, pentanol, benzyl alcohol, cyclohexanol), ketones (for example cyclohexanone, gamma-butyrolactone), pyrrolidones (NMP, NEP, NOP), acetates (glycol diacetate), glycols, fatty acid dimethylamides, fatty acids and fatty acid esters, isophorone and dimethylsulfoxide. In principle, solvent mixtures may also be used.

According to an embodiment, suitable surfactants are alkali metal, alkaline earth metal and ammonium salts of lignosulfonic acid, naphthalenesulfonates, phenolsulfonic acid, dibutylnaphthalenesulfonic acid, alkylarylsulfonates, alkyl sulfates, alkylsulfonates, fatty alcohol sulfates, fatty acids and sulfated fatty alcohol glycol ethers, furthermore condensates of sulfonated naphthalene and naphthalene derivatives with formaldehyde, condensates of naphthalene or of naphthalenesulfonic acid with phenol and formaldehyde, polyoxyethylene octylphenol ethers, ethoxylated isooctylphenol, octylphenol, nonylphenol, alkylphenol polyglycol ethers, tributylphenyl polyglycol ethers, tristearylphenyl polyglycol ethers, alkylaryl polyether alcohols, alcohol and fatty alcohol/ethylene oxide condensates, ethoxylated castor oil, polyoxyethylene alkyl ethers, ethoxylated polyoxypropylene, lauryl alcohol polyglycol ether acetal, sorbitol esters, lignosulfite waste liquors and methylcellulose.

According to an embodiment, examples of suitable carriers are mineral earths such as silica gels, silicates, talc, kaolin, attaclay, attapulgite, limestone, lime, chalk, bole, loess, clay, dolomite, diatomaceous earth, calcium sulfate, magnesium sulfate, magnesium oxide, ground synthetic materials, fertilizers, such as, for example, ammonium sulfate, ammonium phosphate, ammonium nitrate, ureas, and products of vegetable origin, such as cereal meal, tree bark meal, wood meal and nutshell meal, cellulose powders, polyvinylpyrrolidone and other solid carriers.).

Suitable preservatives are for example 1,2-benzisothiazolin-3-one and/or 2-Methyl-2H-isothiazol-3-one or sodium benzoate or benzoic acid.

In an embodiment, the composition may be in any agriculturally suitable form for storage and application to the foliage or the ground. The compositions of the present invention may typically be produced by mixing the actives in the composition with an inert carrier, and adding surfactants and other adjuvants and carriers as needed and formulated into solid, or liquid formulations, including but not limited to wettable powders, granules, dusts, Soluble (liquid) concentrates, suspension concentrates, oil in water emulsion, water in oil emulsion, emulsifiable concentrates, capsule suspensions, ZC formulations, oil dispersions or other known formulation types. The composition may also be used for treatment of a plant propagation material such as seeds etc.

The fungicidal combinations and compositions of the present disclosure can be in any conventional agriculturally useful form, for example, in the form of a ready-to-use formulation, or in the form of a tank mix.

In an embodiment, the fungicidal actives may be formulated as a premix product or a ready-to-use product.

In an embodiment, the fungicidal actives may be tank-mixed at the time of application, or prior to the application.

In an embodiment, the fungicidal actives may form said combination or composition at the locus where it is applied in succession or separately.

The use of the combinations/compositions according to the present invention provides for excellent fungicidal effectiveness against a broad spectrum of fungi and fungal pathogens, thus providing an effective control, eradication or prevention of fungal diseases in plants, crops or a part thereof.

An embodiment of the present invention provides a method of controlling fungal infestation of a plant, a crop or a part thereof comprising applying to the plant, the crop or a part thereof a fungicidally effective and/or a synergistic combination comprising a fungicide; and salicylic acid, salts or analogues thereof; or a composition comprising said combination.

An embodiment of the present invention provides a method of controlling fungal infestation of a plant, a crop or a part thereof comprising applying to the plant, the crop or a part thereof a fungicidally effective and/or a synergistic combination comprising a multi-site fungicide; and salicylic acid, salts or analogues thereof; or a composition comprising said combination.

An embodiment of the present invention provides a method of controlling fungal disease in a plant, a crop or a part thereof comprising applying to the plant, the crop or a part thereof a fungicidally effective and/or a synergistic combination comprising a fungicide; and salicylic acid, salts or analogues thereof; or a composition comprising said combination.

An embodiment of the present invention provides a method of controlling fungal disease in a plant, a crop or a part thereof comprising applying to the plant, the crop or a part thereof a fungicidally effective and/or a synergistic combination comprising a multi-site fungicide; and salicylic acid, salts or analogues thereof; or a composition comprising said combination.

An embodiment of the present invention provides a method to improve plant health, growth and yield comprising applying to the plant, the crop or a part thereof a fungicidally effective and/or a synergistic combination comprising a fungicide; and salicylic acid, salts or analogues thereof; or a composition comprising said combination.

An embodiment of the present invention provides a method to improve plant health, growth and yield comprising applying a fungicidally effective and/or a synergistic combination comprising a multi-site fungicide; and salicylic acid, salts or analogues thereof; or a composition comprising said combination.

In an embodiment, said methods comprise applying the fungicide at a rate of about 0.1 g ai/ha to about 1000 g ai/ha.

In an embodiment, said methods comprise applying the fungicide at a rate of about 0.1 g ai/ha to about 2000 g ai/ha.

In an embodiment, said methods comprise applying the multi-site fungicide at a rate of about 0.1 g ai/ha to about 1000 g ai/ha.

In an embodiment, said methods comprise applying the copper fungicide or the copper-based fungicide at a rate of about 1 g ai/ha to about 1000 g ai/ha. In an embodiment, said methods comprise applying the copper fungicide or the copper-based fungicide at a rate of about 5 g ai/ha to about 1000 g ai/ha. In an embodiment, said methods comprise applying the copper fungicide or the copper-based fungicide at a rate of about 5 g ai/ha to about 200 g ai/ha. In an embodiment, said methods comprise applying the copper fungicide or the copper-based fungicide at a rate of about 50 g ai/ha to about 700 g ai/ha. In an embodiment, said methods comprise applying the copper fungicide or the copper-based fungicide at a rate of about 100 g ai/ha to about 500 g ai/ha. In an embodiment, said methods comprise applying the copper fungicide or the copper-based fungicide at a rate of about 150 g ai/ha to about 300 g ai/ha. In an embodiment, said methods comprise applying the copper fungicide or the copper-based fungicide at a rate of about 150 g ai/ha.

In an embodiment, said methods comprise applying mancozeb at a rate of about 0.1 g ai/ha to about 200 g ai/ha.

In an embodiment, said methods comprise applying captan at a rate of about 0.1 g ai/ha to about 200 g ai/ha.

In an embodiment, said methods comprise applying folpet at a rate of about 0.1 g ai/ha to about 200 g ai/ha.

In an embodiment, said methods comprise applying ziram at a rate of about 0.1 g ai/ha to about 200 g ai/ha.

In an embodiment, said methods comprise applying salicylic acid, salts or analogues thereof at a rate of about 0.1 g ai/ha to about 2000 g ai/ha. In an embodiment, said methods comprise applying salicylic acid, salts or analogues thereof at a rate of about 1 g ai/ha to about 1000 g ai/ha. In an embodiment, said methods comprise applying salicylic acid, salts or analogues thereof at a rate of about 1 g ai/ha to about 100 g ai/ha. In an embodiment, said methods comprise applying salicylic acid, salts or analogues thereof at a rate of about 2 g ai/ha to about 80 g ai/ha. In an embodiment, said methods comprise applying salicylic acid, salts or analogues thereof at a rate of about 2 g ai/ha to about 60 g ai/ha. In an embodiment, said methods comprise applying salicylic acid, salts or analogues thereof at a rate of about 2 g ai/ha to about 40 g ai/ha. In an embodiment, said methods comprise applying salicylic acid, salts or analogues thereof at a rate of about 2 g ai/ha to about 20 g ai/ha.

In an embodiment, said methods comprise applying salicylic acid, salts or analogues thereof at a rate of about 0.1 g ai/ha to about 21 g ai/ha.

In an embodiment, methods of the present invention comprises applying the combinations or compositions of the present invention simultaneously, that is jointly; or separately, that is in succession.

In another embodiment, the constituents of the combinations or compositions of the present invention may be tank mixed and applied or sprayed at the locus of the infection or may be alternatively mixed with surfactants and/or any other agrochemically suitable excipients and then applied.

In yet another embodiment, the constituents of the combinations of the present invention may be applied in such quick succession in any order to form the desired mix at the locus of application.

In an embodiment, the constituents of the combination or the composition of the present invention may be used for foliar application, ground or applications to plant propagation materials.

In an embodiment, 10%-90% dose reduction of the fungicide as compared to the standard farmer practice is achieved through the combinations, compositions or methods encompassed by the present invention.

In an embodiment, 10%-90% dose reduction of the multi-site fungicide as compared to the standard farmer practice is achieved through the combinations, compositions or methods encompassed by the present invention.

An embodiment of the present invention provides a use of a fungicidally effective combination comprising a fungicide; and salicylic acid, salts or analogues thereof; or a composition comprising said combination for controlling fungal infestation and/or fungal disease of a plant, a crop, or a part thereof.

An embodiment of the present invention provides a use of a fungicidally effective combination comprising a multi-site fungicide; and salicylic acid, salts or analogues thereof; or a composition comprising said combination for controlling fungal infestation and/or fungal disease of a plant, a crop, or a part thereof.

An embodiment of the present invention provides a use of a synergistic fungicidal combination comprising a fungicide; and salicylic acid, salts or analogues thereof; or a composition comprising said combination for controlling fungal infestation and/or fungal disease of a plant, a crop, or a part thereof.

An embodiment of the present invention provides a use of a synergistic fungicidal combination comprising a multi-site fungicide; and salicylic acid, salts or analogues thereof; or a composition comprising said combination for controlling fungal infestation and/or fungal disease of a plant, a crop, or a part thereof.

The combinations and/or compositions of the present invention may be used to treat following fungal and bacterial diseases of a plant, a crop, or a part thereof: Disease in rice: Blast (Magnaporthe grisea), Helminthosporium leaf spot (Cochiobolus miyabeanus), sheath blight (Rhizoctonia solani), and bakanae disease (Gibberella fujikuroi).

Diseases in wheat: powdery mildew (Erysiphe graminis), Fusarium head blight (Fusarium graminearum, F. avenacerum, F. culmorum, Microdochium nivale), rust (Puccinia striiformis, P. graminis, P. recondita), pink snow mold (Micronectriella nivale), Typhula snow blight (Typhula sp.), loose smut (Ustilago tritici), bunt (Tilletia caries), eyespot (Pseudocercosporella herpotrichoides), leaf blotch (Mycosphaerella graminicola), glume blotch (Stagonospora nodorum), septoria, and yellow spot (Pyrenophora tritici-repentis).
Diseases of barley: powdery mildew (Erysiphe graminis), Fusarium head blight (Fusarium graminearum, F. avenacerum, F. culmorum, Microdochium nivale), rust (Puccinia striiformis, P. graminis, P. hordei), loose smut (Ustilago nuda), scald (Rhynchosporium secalis), net blotch (Pyrenophora teres), spot blotch (Cochliobolus sativus), leaf stripe (Pyrenophora graminea), and Rhizoctonia damping-off (Rhizoctonia solani).
Diseases in corn: smut (Ustilago maydis), brown spot (Cochliobolus heterostrophus), copper spot (Gloeocercospora sorghi), southern rust (Puccinia polysora), gray leaf spot (Cercospora zeae-maydis), white spot (Phaeosphaeria mydis and/or Pantoea ananatis) and Rhizoctonia damping-off (Rhizoctonia solani).
Diseases of citrus: melanose (Diaporthe cirri), scab (Elsinoe fawcetti), penicillium rot (Penicillium digitatum, P. italicum), and brown rot (Phytophthora parasitica, Phytophthora citrophthora).
Diseases of apple: blossom blight (Monilinia mali), canker (Valsa ceratosperma), powdery mildew (Podosphaera leucotricha), Alternaria leaf spot (Alternaria alternata apple pathotype), scab (Venturia inaequalis), powdery mildew, bitter rot (Colletotrichum acutatum), crown rot (Phytophtora cactorum), blotch (Diplocarpon mali), and ring rot (Botryosphaeria berengeriana).
Diseases of pear: scab (Venturia nashicola, V. pirina), powdery mildew, black spot (Alternaria alternata Japanese pear pathotype), rust (Gymnosporangium haraeanum), and phytophthora fruit rot (Phytophtora cactorum).
Diseases of peach: brown rot (Monilinia fructicola), powdery mildew, scab Cladosporium carpophilum), and phomopsis rot (Phomopsis sp.).
Diseases of grape: anthracnose (Elsinoe ampelina), ripe rot (Glomerella cingulata), powdery mildew (Uncinula necator), rust (Phakopsora ampelopsidis), black rot (Guignardia bidwellii), Botrytis, and downy mildew (Plasmopara viticola).
Diseases of Japanese persimmon: anthracnose (Gloeosporium kaki), and leaf spot (Cercospora kaki, Mycosphaerella nawae).
Diseases of gourd: anthracnose (Colletotrichum lagenarium), powdery mildew (Sphaerotheca fuliginea), gummy stem blight (Mycosphaerella melonis), Fusarium wilt (Fusarium oxysporum), downy mildew (Pseudoperonospora cubensis), Phytophthora rot (Phytophthora sp.), and damping-off (Pythium sp).
Diseases of tomato: early blight (Alternaria solani), leaf mold (Cladosporium fulvum), and late blight (Phytophthora infestans).
Diseases of eggplant: brown spot (Phomopsis vexans), and powdery mildew (Erysiphe cichoracearum).
Diseases of cruciferous vegetables: Alternaria leaf spot (Alternaria japonica), white spot (Cercosporella brassicae), clubroot (Plasmodiophora brassicae), and downy mildew (Peronospora parasitica).
Diseases of onion: rust (Puccinia allii), and downy mildew (Peronospora destructor).
Diseases of soybean: purple seed stain (Cercospora kikuchii), sphaceloma scad (Elsinoe glycines), pod and stem blight (Diaporthe phaseolorum var. sojae), septoria brown spot (Septoria glycines), frogeye leaf spot (Cercospora sojina), rust (Phakopsora pachyrhizi), Yellow rust, brown stem rot (Phytophthora sojae), and Rhizoctonia damping-off (Rhizoctonia solani).
Diseases of kidney bean: anthracnose (Colletotrichum lindemthianum). Diseases of peanut: leaf spot (Cercospora personata), brown leaf spot (Cercospora arachidicola) and southern blight (Sclerotium rolfsii).
Diseases of garden pea: powdery mildew (Erysiphe pisi), and root rot (Fusarium solani f. sp. pisi).
Diseases of potato: early blight (Alternaria solani), late blight (Phytophthora infestans), pink rot (Phytophthora erythroseptica), and powdery scab (Spongospora subterranean f. sp. subterranea).
Diseases of strawberry: powdery mildew (Sphaerotheca humuli), and anthracnose (Glomerella cingulata).
Diseases of tea: net blister blight (Exobasidium reticulatum), white scab (Elsinoe leucospila), gray blight (Pestalotiopsis sp.), and anthracnose (Colletotrichum theae-sinensis).
Diseases of tobacco: brown spot (Alternaria longipes), powdery mildew (Erysiphe cichoracearum), anthracnose (Colletotrichum tabacum), downy mildew (Peronospora tabacina), and black shank (Phytophthora nicotianae).
Diseases of rapeseed: sclerotinia rot (Sclerotinia sclerotiorum), and Rhizoctonia damping-off (Rhizoctonia solani). Diseases of cotton: Rhizoctonia damping-off (Rhizoctonia solani). Diseases of sugar beat: Cercospora leaf spot (Cercospora beticola), leaf blight (Thanatephorus cucumeris), Root rot (Thanatephorus cucumeris), and Aphanomyces root rot (Aphanomyces cochlioides). Diseases of rose: black spot (Diplocarpon rosae), powdery mildew (Sphaerotheca pannosa), and downy mildew (Peronospora sparsa). Diseases of chrysanthemum and asteraceous plants: downy mildew (Bremia lactucae), leaf blight (Septoria chrysanthemi-indici), and white rust (Puccinia horiana).
Diseases of various other crops: diseases caused by Pythium spp. (Pythium aphanidermatum, Pythium debarianum, Pythium graminicola, Pythium irregulare, Pythium ultimum), gray mold. (Botrytis cinerea), and Sclerotinia rot (Sclerotinia sclerotiorum).
Disease of Japanese radish: Alternaria leaf spot (Alternaria brassicicola).
Diseases of turfgrass: dollar spot (Sclerotinia homeocarpa), and brown patch and large patch (Rhizoctonia solani).
Disease of banana: Black sigatoka (Mycosphaerella fijiensis), Yellow sigatoka (Mycosphaerella musicola).
Disease of sunflower: downy mildew (Plasmopara halstedii).
Seed diseases or diseases in the early stages of the growth of various plants caused by Aspergillus spp., Penicillium spp., Fusarium spp., Gibberella spp., Tricoderma spp., Thielaviopsis spp., Rhizopus spp., Mucor spp., Corticium spp., Phoma spp., Rhizoctonia spp. and Diplodia spp.

An embodiment of the present invention provides a kit-of-parts comprising a first component comprised of a fungicide, and a second component comprised of salicylic acid, salts or analogues thereof. The first and/or second components may further comprise an agriculturally acceptable excipient.

An embodiment of the present invention provides a kit-of-parts comprising a first component comprised of a multi-site fungicide, and a second component comprised of salicylic acid, salts or analogues thereof. The first and/or second components may further comprise an agriculturally acceptable excipient.

An embodiment of the present invention provides a kit-of-parts comprising a first component comprised of a multi-site fungicide, a second component comprised of salicylic acid, salts or analogues thereof; and optionally a third or more components comprised of an agriculturally acceptable excipient.

An embodiment of the present invention provides a kit-of-parts comprising a first component comprised of a multi-site fungicide, a second component comprised of salicylic acid, salts or analogues thereof; and optionally a third or more components comprised of an agriculturally acceptable excipient.

This effectiveness of all treatments can be evaluated according to Colby's equation. In the Colby's equation given below, E is the expected efficacy of combination of the fungicide, and salicylic acid, salts or analogues thereof,

X is the observed efficacy of the fungicide, and

Y is the observed efficacy of salicylic acid, salts or analogues thereof.

Observed efficacy values i.e. X and Y are % disease control for the fungicide and salicylic acid, salts or analogues thereof. If observed efficacy of combination of the fungicide and salicylic acid, salts or analogues thereof is greater than its expected efficacy, then combination is determined to be synergistic. If observed efficacy is equal to or less than expected efficacy, then combination is determined to be non-synergistic.

$$E = X + Y - XY / 100 \qquad Colby ' s equation$$

The results of synergistic effects of the present combinations/compositions is represented in examples. As used herein, all numerical values or numerical ranges include integers within such ranges and fractions of the values or the integers within ranges unless the context clearly indicates otherwise. Thus, for example, reference to a range of 90-100%, includes 91%, 92%, 93%, 94%, 95%, 95%, 97%, etc., as well as 91.1%, 91.2%, 91.3%, 91.4%, 91.5%, etc., 92.1%, 92.2%, 92.3%, 92.4%, 92.5%, etc., and so forth.

Specifically, the invention includes embodiments in which particular subject matter is excluded, in full or in part, such as substances or materials, method steps and conditions, protocols, procedures, assays or analysis. Thus, even though the invention is generally not expressed herein in terms of what the invention does not include aspects that are not expressly included in the invention are nevertheless disclosed herein. Although a number of embodiments of the invention have been described, it will be understood that various modifications may be made without departing from the spirit and scope of the invention.

These and other advantages of the invention may become more apparent from the examples set forth. These examples are provided merely as illustrations of the invention and are not intended to be construed as a limitation thereof.

### EXAMPLES

### Example 1: Efficacy of Copper-Based Fungicide and Salicylic Acid on Alternaria solani in Tomato (Early Blight Disease)

150 g ai/ha copper-based fungicide, namely tribasic copper sulphate and 20 g ai/ha salicylic acid were combined to check efficacy on early blight disease causing Alternaria solani in a greenhouse experiment. 3.5 week old cultivated tomato plants' leaves were sprayed with spore suspension of Alternaria solani till run-off. The inoculated plants were maintained in the incubation chamber for 2 days. Lesion areas were measured on 1^{st} and 2^{nd} primary leaflets at 4 dpi using ImageJ. Following table 1 illustrates the treatments and efficacy observed for the combination against the disease/pathogen. A standard treatment of tribasic copper sulphate at 700 g ai/ha was used as a comparative reference.

TABLE 1
Efficacy of tribasic copper sulphate and salicylic acid on
early blight disease causing Alternaria solani in tomato

| | Application rate | | Expected % |
|---|---|---|---|
| | (g/HA of | Observed | efficacy as per |
| Treatment | Cu or SA) | efficacy % | Colby formula |
| Control | — | 0 | |
| tribasic copper | 150 | 31 | |
| sulphate (Cu 55%) | | | |
| tribasic copper | 700 | 88 | |
| sulphate (Cu 55%) | | | |
| Salicylic acid | 20 | 13.3 | |
| tribasic copper | 150 + 20 | 88.4 | 40.177 |
| sulphate (Cu 55%) + | | | |
| salicylic acid | | | |

### Example 2: Efficacy of Copper-Based Fungicide and Salicylic Acid on Alternaria solani in Tomato (Early Blight Disease)

0.75 g/L tribasic copper sulphate and various concentrations of salicylic acid were combined to check efficacy on early blight disease causing Alternaria solani in a greenhouse experiment. Salicylic acid concentrations of 40 mg/L, 80 mg/L, 160 mg/L, and 320 mg/L were used in the experiment. 3.5 week old cultivated tomato plants' leaves were sprayed with spore suspension of Alternaria solani till run-off. The inoculated plants were maintained in the incubation chamber for 2 days. Lesion areas were measured on 1^{st} and 2^{nd} primary leaflets at 4 dpi using ImageJ. Following table 2 illustrates the treatments and efficacy observed for the combination against the disease/pathogen. A standard treatment of 17.5 g/L tribasic copper sulphate was used as a comparative reference.

TABLE 2
Efficacy of tribasic copper sulphate and salicylic acid on
early blight disease causing Alternaria solani in tomato

| | | | Expected % |
|---|---|---|---|
| | Application rate | Observed | efficacy as per |
| Treatment | (g ai/ha) | efficacy % | Colby formula |
| Control | — | 0 | |
| tribasic copper | 150 g Cu/HA | 40.2 | |
| sulphate 0.75 g/L | | | |
| tribasic copper | 700 g Cu/HA | 86.9 | |
| sulphate 17.5 g/L | | | |
| Salicylic acid (SA) 40 | 2.5 g SA/HA | 23.4 | |
| mg/L | | | |
| tribasic copper | 150 g Cu/HA + | 26.6 | 54.19 |
| sulphate 0.75 g/L + | 2.5 g SA/HA | | |
| salicylic acid 40 mg/L | | | |
| SA (80 mg/L) | 5 g SA/HA | 22.1 | |
| tribasic copper | 150 g Cu/HA + | 43.8 | 53.42 |
| sulphate 0.75 g/L + | 5 g SA/HA | | |
| Salicylic acid (80 | | | |
| mg/L) | | | |
| Salicylic acid (320 | 10 g/HA | −2.3 | |
| mg/L) | | | |
| tribasic copper | 150 g Cu/HA + | 50.8 | 38.82 |
| sulphate 0.75 g/L + | 10 g SA/HA | | |
| Salicylic acid (320 | | | |
| mg/L) | | | |
| Salicylic acid (320 | 20 g/HA | −2.7 | |
| mg/L) | | | |
| tribasic copper | 150 g Cu/HA + | 79.4 | 38.58 |
| sulphate 0.75 g/L + | 20 g SA/HA | | |
| Salicylic acid (320 | | | |
| mg/L) | | | |

### Example 3: Efficacy of Copper-Based Fungicide and Potassium Salicylate on Alternaria solani in Tomato (Early Blight Disease)

0.75 g/L tribasic copper sulphate and various two concentrations of potassium salicylate were combined to check efficacy on early blight disease causing Alternaria solani in a greenhouse experiment. Potassium salicylate concentrations of 320 mg/L, and 410 mg/L were used in the experiment. 3.5 week old cultivated tomato plants' leaves were sprayed with spore suspension of Alternaria solani till run-off. The inoculated plants were maintained in the incubation chamber for 2 days. Lesion areas were measured on 1^{st} and 2^{nd} primary leaflets at 4 dpi using ImageJ. Following table 3 illustrates the treatments and efficacy observed for the combination against the disease/pathogen. A standard treatment of 17.5 g/L tribasic copper sulphate was used as a comparative reference.

TABLE 3
Efficacy of tribasic copper sulphate and salicylic acid on
early blight disease causing Alternaria solani in tomato

| | Observed | Expected % efficacy |
|---|---|---|
| Treatment | efficacy % | as per Colby formula |
| Control | 0 | |
| tribasic copper sulphate 0.75 g/L | 23 | |
| tribasic copper sulphate 17.5 g/L | 75 | |
| Potassium salicylate 410 mg/L | 5.8 | |
| tribasic copper sulphate 0.75 g/L + | 69.1 | 27.46 |
| potassium salicylate 410 mg/L | | |

### Example 4: Effect of Tribasic Copper Sulphate with Potassium Salicylate on Cucumber Downy Mildew

0.13 g/L tribasic copper sulphate and 71 mg/L potassium salicylate were combined to check efficacy on downy mildew disease in a greenhouse experiment. A standard treatment of 17.5 g/L tribasic copper sulphate was used as a comparative reference.

TABLE 4
Effect of tribasic copper sulphate with potassium
salicylate on cucumber downy mildew

| | | | Expected |
|---|---|---|---|
| | Application rate | Observed | efficacy as per |
| Treatment | (~g ai/ha) | efficacy | Colby formula |
| Control | — | 0 | |
| tribasic copper | 700 g Cu/HA | 94.9 | |
| sulphate 17.5 g/L | | | |
| tribasic copper | 5.2 g Cu/HA | −7.6 | |
| sulphate 0.13 g/L | | | |
| potassium salicylate | 0.89 g SA/HA | 21.9 | |
| 71 mg/L | | | |
| tribasic copper | 5.2 g Cu/HA + | 59.0 | 15.97 |
| sulphate 0.13 g/L + | 0.89 g KSA/HA | | |
| potassium salicylate | | | |
| 71 mg/L | | | |

### Example 5: Effect of Tribasic Copper Sulphate with Potassium Salicylate on Tomato Late Blight Disease

0.25 g/L tribasic copper sulphate and 137 mg/L potassium salicylate were combined to check efficacy on tomato late blight disease in a greenhouse experiment. A standard treatment of 0.75 g/L tribasic copper sulphate was used as a comparative reference.

TABLE 5
Effect of tribasic copper sulphate with potassium
salicylate on tomato late blight disease

| | | | Expected % |
|---|---|---|---|
| | Application rate | Observed | efficacy as per |
| Treatment | (~g ai/ha) | efficacy % | Colby formula |
| Control | — | 0 | |
| tribasic copper | 30 g Cu/HA | 62.9 | |
| sulphate 0.75 g/L | | | |
| tribasic copper | 10 g Cu/HA | 18.5 | |
| sulphate 0.25 g/L | | | |
| Potassium Salicylate | 1.7 g SA/HA | 15.2 | |
| 137 mg/L | | | |
| tribasic copper | 10 g Cu/HA + | 47.5 | 30.88 |
| sulphate 0.25 g/L + | 1.7 g KSA/HA | | |
| potassium salicylate | | | |
| 137 mg/L | | | |

### Example 6: Effect Oftribasic Copper Sulphate with Potassium Salicylate on Tomato Early Blight Disease

0.75 g/L tribasic copper sulphate and 310 mg/L, 410 mg/L and 620 mg/L potassium salicylate were combined to check efficacy on tomato early blight disease in a greenhouse experiment. A standard treatment of 17.5 g/L tribasic copper sulphate was used as a comparative reference.

TABLE 6
Effect of tribasic copper sulphate with potassium
salicylate on tomato early blight disease

| | | | Expected % |
|---|---|---|---|
| | Application rate | Observed | efficacy as per |
| Treatment | (~g ai/ha) | efficacy % | Colby formula |
| Control | — | 0 | |
| tribasic copper | 30 g Cu/HA | 18.5 | |
| sulphate 0.75 g/L | | | |
| tribasic copper | 700 g Cu/HA | 57.6 | |
| sulphate 17.5 g/L | | | |
| potassium salicylate | 3.875 g SA/HA | 2.2 | |
| 310 mg/L | | | |
| tribasic copper | 30 g Cu/HA + | 25.2 | 20.293 |
| sulphate 0.75 g/L + | 3.875 g KSA/HA | | |
| potassium salicylate | | | |
| 310 mg/L | | | |
| potassium salicylate | 5.125 g SA/HA | 13.1 | |
| 410 mg/L | | | |
| tribasic copper | 30 g Cu/HA + | 60.7 | 29.17 |
| sulphate 0.75 g/L + | 5.125 g KSA/HA | | |
| potassium salicylate | | | |
| 410 mg/L | | | |
| potassium salicylate | 7.75 g/HA | 11.4 | |
| 620 mg/L | | | |
| tribasic copper | 30 g Cu/HA + | 45.2 | 27.79 |
| sulphate 0.75 g/L + | 7.75 g KSA/HA | | |
| potassium salicylate | | | |
| 620 mg/L | | | |

### Example 7: Combination of Mancozeb and Potassium Salicylate

Following trials were conducted on crops (potted plants) infected with the pathogen/disease in a greenhouse trial.

TABLE 7
Combination of mancozeb and potassium salicylate and
efficacy on pathogens/diseases in different crops

| | | | Application | | |
|---|---|---|---|---|---|
| | | | rate in gai/ha | | |
| | | | (based on | | |
| | | | 100 liters | | |
| | Pathogen/ | | per hectare | Efficacy | Colby |
| Crop | Disease | Treatment | spray volume | (%) | (%) |
| Pepper | Botrytis | potassium salicylate | 0.31 | −5.2 | |
| | | (0.025 g/l) | | | |
| Pepper | Botrytis | potassium salicylate | 1.25 | −3.9 | |
| | | (0.1 g/l) | | | |
| Pepper | Botrytis | mancozeb (0.0168 g/l) | 1.26 | 26.4 | |
| Pepper | Botrytis | mancozeb (0.0168 g/l) + | 1.26 + 0.31 | 49.5 | 22.6 |
| | | potassium salicylate | | | |
| | | (0.025 g/l) | | | |
| Pepper | Botrytis | mancozeb (0.0168 g/l) + | 1.26 + 1.25 | 45.1 | 23.6 |
| | | potassium salicylate | | | |
| | | (0.1 g/l) | | | |
| Tomato | Early | potassium salicylate | 5.13 | −3 | |
| | Blight | (0.41 g/l) | | | |
| Tomato | Early | mancozeb (0.0187 g/l) | 1.4 | −12.6 | |
| | Blight | | | | |
| Tomato | Early | mancozeb (0.0187 g/l) + | 1.4 + 5.13 | 14.9 | −16 |
| | Blight | potassium salicylate | | | |
| | | (0.41 g/l) | | | |
| Soybean | Target | potassium salicylate | 0.31 | 16.8 | |
| | Spot | (0.025 g/l) | | | |
| Soybean | Target | potassium salicylate | 1.25 | 12.6 | |
| | Spot | (0.1 g/l) | | | |
| Soybean | Target | potassium salicylate | 5.13 | 27.6 | |
| | Spot | (0.41 g/l) | | | |
| Soybean | Target | potassium salicylate | 10.25 | −3.8 | |
| | Spot | (0.82 g/l) | | | |
| Soybean | Target | potassium salicylate | 20.5 | 6.3 | |
| | Spot | (1.64 g/l) | | | |
| Soybean | Target | mancozeb (0.0075 g/l) | 0.56 | −6.6 | |
| | Spot | | | | |
| Soybean | Target | mancozeb (0.0075 g/l) + | 0.56 + 0.31 | 27.5 | 11.3 |
| | Spot | potassium salicylate | | | |
| | | (0.025 g/l) | | | |
| Soybean | Target | mancozeb (0.0075 g/l) + | 0.56 + 1.25 | 17.3 | 6.8 |
| | Spot | potassium salicylate | | | |
| | | (0.1 g/l) | | | |
| Soybean | Target | mancozeb (0.0075 g/l) + | 0.56 + 5.13 | 42.7 | 22.8 |
| | Spot | potassium salicylate | | | |
| | | (0.41 g/l) | | | |
| Soybean | Target | mancozeb (0.0075 g/l)) + | 0.56 + 10.25 | 19.6 | −10.7 |
| | Spot | potassium salicylate | | | |
| | | (0.82 g/l) | | | |
| Soybean | Target | mancozeb (0.0075 g/l) + | 0.56 + 20.5 | 21 | 0.1 |
| | Spot | potassium salicylate | | | |
| | | (1.64 g/l) | | | |
| Pepper | Botrytis | potassium salicylate | 0.31 | −5.2 | |
| | | (0.025 g/l) | | | |
| Pepper | Botrytis | potassium salicylate | 1.25 | −3.9 | |
| | | (0.1 g/l) | | | |
| Pepper | Botrytis | captan (0.002 g/l) | 0.16 | 20.4 | |
| Pepper | Botrytis | captan (0.002 g/l) + | 0.16 + 0.31 | 24.5 | 16.3 |
| | | potassium salicylate | | | |
| | | (0.025 g/l) | | | |
| Pepper | Botrytis | captan (0.002 g/l) + | 0.16 + 1.25 | 27.7 | 17.4 |
| | | potassium salicylate | | | |
| | | (0.1 g/l) | | | |
| Soybean | Target | potassium salicylate | 0.31 | 19.5 | |
| | Spot | (0.025 g/l) | | | |
| Soybean | Target | potassium salicylate | 1.25 | 12.4 | |
| | Spot | (0.1 g/l) | | | |
| Soybean | Target | potassium salicylate | 5.13 | 1.8 | |
| | Spot | (0.41 g/l) | | | |
| Soybean | Target | potassium salicylate | 10.25 | −6.1 | |
| | Spot | (0.82 g/l) | | | |
| Soybean | Target | potassium salicylate | 20.5 | −11.4 | |
| | Spot | (1.64 g/l) | | | |
| Soybean | Target | captan (0.02 g/l) + | 1.6 + 0.31 | 22 | 19.8 |
| | Spot | potassium salicylate | | | |
| | | (0.025 g/l) | | | |
| Soybean | Target | captan (0.02 g/l) + | 1.6 + 1.25 | 72.7 | 12.7 |
| | Spot | potassium salicylate | | | |
| | | (0.1 g/l) | | | |
| Soybean | Target | captan (0.02 g/l) + | 1.6 + 5.13 | 87 | 2.2 |
| | Spot | potassium salicylate | | | |
| | | (0.41 g/l) | | | |
| Soybean | Target | captan (0.02 g/l) + | 1.6 + 10.25 | 46 | −5.8 |
| | Spot | potassium salicylate | | | |
| | | (0.82 g/l) | | | |
| Soybean | Target | captan (0.02 g/l) + | 1.6 + 20.5 | 52.7 | −11 |
| | Spot | potassium salicylate | | | |
| | | (1.64 g/l) | | | |
| Pepper | Botrytis | potassium salicylate | 1.25 | 12 | |
| | | (0.1 g/l) | | | |
| Pepper | Botrytis | folpet (0.002 ml/l) | 0.1 | 9.3 | |
| Pepper | Botrytis | folpet (0.002 ml/l) + | 0.1 + 1.25 | 71.3 | 20.2 |
| | | potassium salicylate | | | |
| | | (0.1 g/l) | | | |
| Soybean | Target | potassium salicylate | 0.31 | 19.5 | |
| | Spot | (0.025 g/l) | | | |
| Soybean | Target | potassium salicylate | 1.25 | 12.4 | |
| | Spot | (0.1 g/l) | | | |
| Soybean | Target | potassium salicylate | 5.13 | 1.8 | |
| | Spot | (0.41 g/l) | | | |
| Soybean | Target | potassium salicylate | 10.25 | −6.1 | |
| | Spot | (0.82 g/l) | | | |
| Soybean | Target | potassium salicylate | 20.5 | −11.4 | |
| | Spot | (1.64 g/l) | | | |
| Soybean | Target | folpet (0.015 g/l) | 0.625 | 34.7 | |
| | Spot | | | | |
| Soybean | Target | folpet (0.015 g/l) + | 0.625 + 0.31 | 62.4 | 47.5 |
| | Spot | potassium salicylate | | | |
| | | (0.025 g/l) | | | |
| Soybean | Target | folpet (0.015 g/l) + | 0.625 + 1.25 | 46.7 | 42.8 |
| | Spot | potassium salicylate | | | |
| | | (0.1 g/l) | | | |
| Soybean | Target | folpet (0.015 g/l) + | 0.625 + 5.13 | 78.7 | 35.9 |
| | Spot | potassium salicylate | | | |
| | | (0.41 g/l) | | | |
| Soybean | Target | folpet (0.015 g/l) + | 0.625 + 10.25 | 69.7 | 30.7 |
| | Spot | potassium salicylate | | | |
| | | (0.82 g/l) | | | |
| Soybean | Target | folpet (0.015 g/l) + | 0.625 + 20.5 | 55.3 | 27.3 |
| | Spot | potassium salicylate | | | |
| | | (1.64 g/l) | | | |

### Example 8: Efficacy of Captan+Potassium Salicylate and Folpet+Potassium Salicylate on Soybean Target Spot (Corynespora cassicola)

Varying concentrations of potassium salicylate were combined with captan/folpet and applied on potted soybean plants in a greenhouse trial, wherein the soybean was infected with soybean target spot. For comparison, a full recommended dose of captan/folpet was used as reference.

TABLE 8
Efficacy of Captan + Potassium salicylate and folpet + Potassium
salicylate on Soybean Target Spot (Corynespora cassicola)

| | Application rate in | | |
|---|---|---|---|
| | gai/ha (based on 100 | | |
| | liters per hectare | Efficacy | Colby |
| Treatment | spray volume | (%) | (%) |
| Control | — | 0 | |
| Potassium Salicylate | 0.31 g KSA/ha | 19.5 | |
| 25 mg/L | | | |
| Potassium Salicylate | 1.25 g KSA/ha | 12.4 | |
| 100 mg/L | | | |
| Potassium Salicylate | 5.13 g KSA/ha | 1.8 | |
| 410 mg/L | | | |
| Potassium Salicylate | 10.27 g KSA/ha | −6.1 | |
| 820 mg/L | | | |
| Potassium Salicylate | 20.54 g KSA/ha | −11.4 | |
| 1.64 g/L | | | |
| Captan 6 g/L | 467 g Captan/ha | 100 | |
| Captan 0.02 g/L | 1.56 g Captan/ha | 0.4 | |
| Captan 0.02 g/L + | 1.56 g Captan/ha + | 22 | 19.8 |
| Potassium Salicylate | 0.31 g KSA/ha | | |
| 25 mg/L | | | |
| Captan 0.02 g/L + | 1.56 g Captan/ha + | 72.7 | 12.7 |
| Potassium Salicylate | 1.25 g KSA/ha | | |
| 100 mg/L | | | |
| Captan 0.02 g/L + | 1.56 g Captan/ha + | 87 | 2.2 |
| Potassium Salicylate | 5.13 g KSA/ha | | |
| 410 mg/L | | | |
| Captan 0.02 g/L + | 1.56 g Captan/ha + | 46 | −5.8 |
| Potassium Salicylate | 10.27 g KSA/ha | | |
| 820 mg/L | | | |
| Captan 0.02 g/L + | 1.56 g Captan/ha + | 52.7 | −11 |
| Potassium Salicylate | 20.54 g KSA/ha | | |
| 1.64 g/L | | | |
| Folpet 5 g/L | 208.5 g Folpet/ha | 98.4 | |
| Folpet 0.015 g/L | 0.63 g Folpet/ha | 34.7 | |
| Folpet 0.015 g/L + | 0.63 g Folpet/ha + | 62.4 | 47.5 |
| Potassium Salicylate | 0.31 g KSA/ha | | |
| 25 mg/L | | | |
| Folpet 0.015 g/L + | 0.63 g Folpet/ha + | 46.7 | 42.8 |
| Potassium Salicylate | 1.25 g KSA/ha | | |
| 100 mg/L | | | |
| Folpet 0.015 g/L + | 0.63 g Folpet/ha + | 78.7 | 35.9 |
| Potassium Salicylate | 5.13 g KSA/ha | | |
| 410 mg/L | | | |
| Folpet 0.015 g/L + | 0.63 g Folpet/ha + | 69.7 | 30.7 |
| Potassium Salicylate | 10.27 g KSA/ha | | |
| 820 mg/L | | | |
| Folpet 0.015 g/L + | 0.63 g Folpet/ha + | 55.3 | 27.3 |
| Potassium Salicylate | 20.54 g KSA/ha | | |
| 1.64 g/L | | | |

### Example 9: Effect of Tribasic Copper Sulphate and Potassium Salicylate on Cucumber Downy Mildew

0.25 g/L tribasic copper sulphate and 103-207 mg/L potassium salicylate were combined to check efficacy on cucumber downy mildew disease in a greenhouse experiment. A standard treatment of 0.75 g/L tribasic copper sulphate was used as a comparative reference.

TABLE 9
Effect of tribasic copper sulphate and potassium
salicylate on cucumber downy mildew

| | | | Expected |
|---|---|---|---|
| | | Ob- | % efficacy |
| | Application | served | as per |
| | rate | efficacy | Colby |
| Treatment | (~g ai/ha) | % | formula |
| Control | — | 0 | |
| tribasic copper sulphate 0.75 g/L | 30 g Cu/HA | 96.7 | |
| tribasic copper sulphate 0.25 g/L | 10 g Cu/HA | 50.7 | |
| potassium salicylate 103 mg/L | 1.29 g KSA/HA | 14.0 | |
| potassium salicylate 137 mg/L | 1.71 g KSA/HA | −1.1 | |
| potassium salicylate 207 mg/L | 2.59 g KSA/HA | −2.7 | |
| tribasic copper sulphate | 10 g Cu/HA + | 77.3 | 57.60 |
| 0.25 g/L + potassium | 1.29 g KSA/HA | | |
| salicylate 103 mg/L | | | |
| tribasic copper sulphate | 10 g Cu/HA + | 99.5 | 50.21 |
| 0.25 g/L + potassium | 1.71 g KSA/HA | | |
| salicylate 137 mg/L | | | |
| tribasic copper sulphate | 10 g Cu/HA + | 63.5 | 49.37 |
| 0.25 g/L + potassium | 2.59 g KSA/HA | | |
| salicylate 0.207 mg/L | | | |

### Example 10: Effect of Combination of Ziram and Potassium Salicylate Tomato Early Blight Disease

Varying concentrations of potassium salicylate were combined with ziram and applied on potted tomato plants in a greenhouse trial, wherein the tomato was infected with early blight. For comparison, a full recommended dose of ziram was used as reference.

TABLE 10
Effect of combination of ziram and potassium
salicylate tomato early blight disease

| | Application | | |
|---|---|---|---|
| | rate in gai/ha | | Expected |
| | (based on 100 | | efficacy % |
| | liters per | | as per |
| | hectare spray | Observed | Colby |
| Treatment | volume | efficacy % | formula |
| Control | — | 0 | |
| Ziram (0.56 g/L) | 42.56 | 91.9 | |
| Ziram (0.014 g/L) | 1.064 | 47.8 | |
| K-SA (0.1 g/L) | 1.25 | 0.4 | |
| K-SA (0.41 g/L) | 5.13 | 2.3 | |
| K-SA (0.82 g/L) | 10.25 | 37.4 | |
| K-SA (1.64 g/L) | 20.5 | 34.4 | |
| Ziram (0.014 g/L) + | 1.064 + 1.25 | 61.2 | 48 |
| K-SA (0.1 g/L) | | | |
| Ziram (0.014 g/L) + | 1.064 + 5.13 | 64.4 | 49.1 |
| K-SA (0.41 g/L) | | | |
| Ziram (0.014 g/L) + | 1.064 + 10.25 | 88.2 | 67.3 |
| K-SA (0.82 g/L) | | | |
| Ziram (0.014 g/L) + | 1.064 + 20.5 | 89.1 | 65.8 |
| K-SA (1.64 g/L) | | | |

From the above examples 1-10 and tables 1-10, it can be observed that a combination of multisite fungicides such as copper/copper-based fungicide/tribasic copper sulphate, mancozeb, folpet, captan, ziram when combined with salicylic acid or potassium salicylate provided more than additive effect in controlling the diseases such as downy mildew in cucumber, early or late blight in tomato, target spot in soybeans, and Botrytis in pepper. Thus, it is evident that the combinations of the present invention provide synergistic control/more than additive effect in controlling a variety of diseases or fungal pathogens in a wide spectrum of crops.

### Abbreviations in Examples

Cu=Copper
SA=Salicylic acid
KSA=Potassium salicylate
g/L or g ai/L=Amount of active ingredient in grams per litre
mg/L or mg ai/L=Amount of active ingredient in milligrams per litre
g/ha or g ai/ha=Amount of active ingredient applied in grams per hectare
mg/ha or mg ai/ha=Amount of active ingredient applied in milligrams per hectare

1. A fungicidal combination comprising a multi-site fungicide; and salicylic acid, salts or analogues thereof.

2. The combination as claimed in claim 1, wherein the multi-site fungicide is an inorganic fungicide selected from copper, copper complexes, copper salts, sulphur, sulphur complexes, sulphur salts, and combinations thereof; a dithio-carbamate selected from amobam, ferbam, mancozeb, maneb, metiram, propineb, thiram, zinc, thiazole, zineb, ziram, and combinations thereof; a phthalimide selected from captan, captafol, folpet, and combinations thereof; a chloronitrile such as chlorothalonil; a sulfamide selected from dichlofluanid, tolylfluanid, and a combination thereof; a bis-guanidine selected from guazatine, iminoctadine, and a combination thereof; a triazine such as anilazine; a quinone such as dithianon; a quinoxaline selected from chinomethionat, quinomethionate, and a combination thereof; a maleimide such as fluoroimide, a thiocarbamate such as
methasulfocarb;
or combinations thereof.

3. The combination as claimed in claim 2, wherein the multi-site fungicide is selected from the group consisting of copper, copper sulphate, tribasic copper sulphate, mancozeb, captan, folpet, chlorothalonil, and combinations thereof.

4. The combination as claimed in claim 1, wherein said combination comprises salicylic acid or potassium salicylate as salt of salicylic acid.

5. The combination as claimed in claim 1, wherein the multi-site fungicide; and salicylic acid, salts or analogues thereof are combined in a ratio ranging from about 1:100 to about 100:1.

6. A fungicidally effective composition comprising a multi-site fungicide; and salicylic acid, salts or analogues thereof.

7. The composition as claimed in claim 6, wherein the composition further comprises an agriculturally acceptable excipient.

8. A method of controlling fungal disease in a plant, a crop or a part thereof or fungal infestation of a plant, a crop or a part thereof comprising applying to the plant, the crop or a part thereof a fungicidally effective combination comprising a multi-site fungicide; and salicylic acid, salts or analogues thereof; or a composition comprising said combination.

9. The method as claimed in claim 8, wherein the multi-site fungicide is applied at a rate of about 0.1 g ai/ha to about 2000 g ai/ha.

10. The method as claimed in claim 8, wherein the salicylic acid, salts or analogues thereof is applied at a rate of about 0.1 g ai/ha to about 2000 g ai/ha.

11-15. (canceled)
